(19) United States
(12) Patent Application Publication
(10) Pub. No.: US 2012/0116586 A1
(43) Pub. Date: May 10, 2012

(54) TEACHING APPARATUS OF ROBOT AND TEACHING METHOD OF ROBOT

(75) Inventor: Yoshinori Fujii, Susono-shi (JP)

(73) Assignee: ULVAC, INC., Chigasaki-shi (JP)

(21) Appl. No.: 13/380,981

(22) PCT Filed: Jun. 30, 2010
(86) PCT No.: PCT/JP2010/004310

§ 371 Date: Dec. 27, 2011

(30) Foreign Application Priority Data
Jun. 30, 2009 (JP) P2009-155723

(51) Int. Cl. B25J 9/16

(52) U.S. Cl. 700/250; 901/3; 901/40; 901/23; 901/31

(57) ABSTRACT

A teaching method of a robot which supports a transported matter with a hand and transports the transported matter between two or more reception spots, includes: a jig disposing process of disposing a positioning jig at the reception spot so as to have the same center axis as the transported matter when the transported matter is placed at the reception spot; and a teaching process of moving the hand to a position at which an abutting portion of the hand abuts the positioning jig at each of the reception spots and teaching the position of the hand to a controller.

### TECHNICAL FIELD

The present invention relates to a teaching method of a robot which teaches operations to a transport robot and a teaching apparatus of a robot, and more specifically, to a technique for accurately teaching a robot within a short time.

Priority is claimed on Japanese Patent Application No. 2009-155723, filed on Jun. 30, 2009, the content of which is incorporated herein by reference.

### BACKGROUND ART

An industrial robot such as a transport robot used for transporting substrates is driven by a predetermined operation program. When the operation program is generated, a skilled personnel called a teaching man actually moves (teaches) a movable portion of a robot such as an arm or a hand according to a desired operation. For example, in a multi-chamber type vacuum apparatus, the stroke of a hand to a stop position, and the angle and height of the hand at the spot position are taught to a robot that transports a substrate.

In addition, the stroke of the hand to the stop position and the angle and the height of the hand at the stop position are detected, by an encoder which converts the stroke or the angle of a movable portion of the robot into numbers and outputs the numbers, and the result is recorded on a controller. In addition, on the basis of the recorded data, an operation program of the robot is generated. During operations of the robot, the movable portion is moved on the basis of the generated operation program.

According to the related art, during teaching of a transport robot which moves a discoid substrate such as a wafer between a plurality of reception spots, a simulated substrate is mounted on a hand that supports the substrate, and a discoid jig is fixed to each of the reception spots by a pin or the like using an opening or the like provided in the hand.

In addition, an index such as a hole is provided at the center of the jig, and the index is detected by a unit for illuminating the index with a laser beam or the like, such that a stop position of the hand at each of the reception spots, for example, a reception position was taught (for example, Patent Document 1).

### PRIORITY DOCUMENT

### Patent Document

[Patent Document 1] Japanese Unexamined Patent Application, First Publication No. 2009-004264

### DISCLOSURE OF INVENTION

### Problems to be Solved by the Invention

However, in a method of adjusting an installation position of a jig used for teaching using a laser beam, a laser beam source and a component (unit) that detects the laser beam is needed, so that there is a problem in that costs of equipments needed for teaching are increased. In addition, adjustment of a floodlight position of the laser beam is needed, so that there is also a problem in that a set up time is taken before teaching is actually performed.

Moreover, since the center axis of a substrate is specified on the basis of the position of the index, for example, a hole or a projection, provided in the hand, there is a problem in that positioning precision of the installation position of the jig used for teaching is degraded. For example, in a case where it is difficult to provide a positioning index, such as a hole or a projection, for representing the center of the position of the substrate placed on the hand, a plurality of indices are provided in the hand, and a jig having an index of the center needs to be installed on the basis of the plurality of indices. Therefore, there is a problem in that positioning precision at the installation position of the jig used for teaching is degraded.

In order to solve the problems, the present invention provides a teaching method of a robot and a teaching apparatus of a robot, capable of teaching a transport robot which transports a transported matter with a substantially discoid shape, within a short time and with high precision, using a simple and easy configuration.

### Means for Solving the Problems

In order to solve the problems, a teaching method of a robot and a teaching apparatus of a robot as follows are provided.

(1) According to an embodiment of the invention, there is provided a teaching method of a robot which supports a transported matter with a hand and transports the transported matter between two or more reception spots, including: a jig disposing process of disposing a positioning jig at the reception spot so as to have the same center axis as the transported matter when the transported matter is placed at the reception spot; and a teaching process of moving the hand to a position at which an abutting portion of the hand abuts the positioning jig at each of the reception spots and teaching the position of the hand to a controller.

(2) The abutting portion may use a surface abutting a peripheral surface of the positioning jig at a position at which the center axis of the positioning jig overlaps the center axis of the transported matter when the transported matter is supported by the hand.

(3) When the positioning jig is disposed at the reception spot, an index may be used which induces the positioning jig to a position at which the center axis of the positioning jig and the center axis of the transported matter overlap each other.

(4) The reception spots may be spots at which the transported matter is received between a plurality of robots.

(5) The robot may be driven by a servo-motor.

(6) The robot may be subjected to an expansion and contraction movement and a turning movement by a concentric biaxial motor.

(7) According to another aspect of the invention, there is provided a teaching apparatus of a robot including: a robot which supports a transported matter with a hand having an abutting surface and transports the transported matter between two or more reception spots; an encoder which is connected to the robot to obtain information regarding the robot; a controller which calculates a position of the hand on the basis of the information obtained by the encoder and generates teaching data for the robot; and a positioning jig which is disposed at the reception spot so as to have the same center axis as the transported matter when the transported matter is placed at the reception spot, when the positioning jig abuts the abutting surface of the hand.

(8) The robot may be a vacuum transport robot.

(9) At least a part of a peripheral surface of the positioning jig may have a curved surface shape, and the abutting surface of the hand may abut the peripheral surface of the positioning jig at least at three points.

(10) The abutting surface of the hand may be a curved surface having the same curvature as an abutting peripheral surface of the positioning jig.

(11) A projection portion may be formed at a surface of the positioning jig, and a recessed portion engaged with the projection portion may be formed at a surface of the reception spot.

(12) A projecting peripheral wall surface may be formed at one surface of the positioning jig, a projecting portion having a peripheral surface that abuts the abutting surface of the hand may be formed at the other surface of the positioning jig, and in a state where the positioning jig is disposed at the reception spot, the reception spot may be stored in the recessed portion provided by the peripheral wall surface.

### Effects of Invention

According to the teaching method of a robot and the teaching apparatus of a robot according to the aspects of the invention, a driving program of a robot which can transport a transported matter accurately and without error can be generated.

Moreover, during such teaching, even though a method which involves time and labor such as disposing an index representing the stop position of the hand at the reception position using laser beams as in the related art is not used, by only disposing the positioning jig at the reception spot, the positioning jig can be easily installed at the center of the reception spot.

### BRIEF DESCRIPTION OF THE DRAWINGS

FIG. 1 is a plan view showing a first configuration example of a transport robot.

FIG. 2A is a side view showing an operation of the transport robot.

FIG. 2B is a plan view showing an operation of the transport robot.

FIG. 2C is a plan view showing an operation of the transport robot.

FIG. 3 is an enlarged plan view showing a hand included in the robot.

FIG. 4 is a cross-sectional view showing a state where a positioning jig is disposed at a reception spot.

FIG. 5A is an explanatory view showing a teaching method of a robot according to a first embodiment of the invention.

FIG. 5B is a cross-sectional view taken along the center line of FIG. 5A.

FIG. 5C is an explanatory view showing the teaching method of a robot according to the same embodiment.

FIG. 5D is an explanatory view showing the teaching method of a robot according to the same embodiment.

FIG. 6 is a plan view showing a configuration example of a teaching method of a robot according to a second embodiment of the invention.

FIG. 7 is a plan view showing a configuration example of a teaching method of a robot according to a third embodiment of the invention.

FIG. 8A is a plan view showing a configuration example of a teaching method of a robot according to a fourth embodiment of the invention.

FIG. 8B is a cross-sectional view of FIG. 8A.

FIG. 9A is a plan view showing a configuration example of a teaching method of a robot according to a fifth embodiment of the invention.

FIG. 9B is a cross-sectional view of FIG. 9A.

FIG. 10 is a cross-sectional view showing a configuration example of a teaching method of a robot according to a sixth embodiment of the invention.

FIG. 11 is a plan view showing a second configuration example of a robot to which the teaching method of a robot of the invention can be applied.

FIG. 12 is a plan view showing a third configuration example of a robot to which the teaching method of a robot of the invention can be applied.

### DETAILED DESCRIPTION OF THE EMBODIMENTS

Hereinafter, a teaching method of a transport robot and a teaching apparatus of a robot according to embodiments of the invention will be described on the basis of the drawings. In addition, the embodiments are examples for better understanding of the essentials of the invention and do not limit the invention unless otherwise indicated. In addition, the drawings in the following description may enlarge parts that are main portions to be shown for ease of understanding of the features of the invention, and are not limited to the same dimension ratios of the components as in practice.

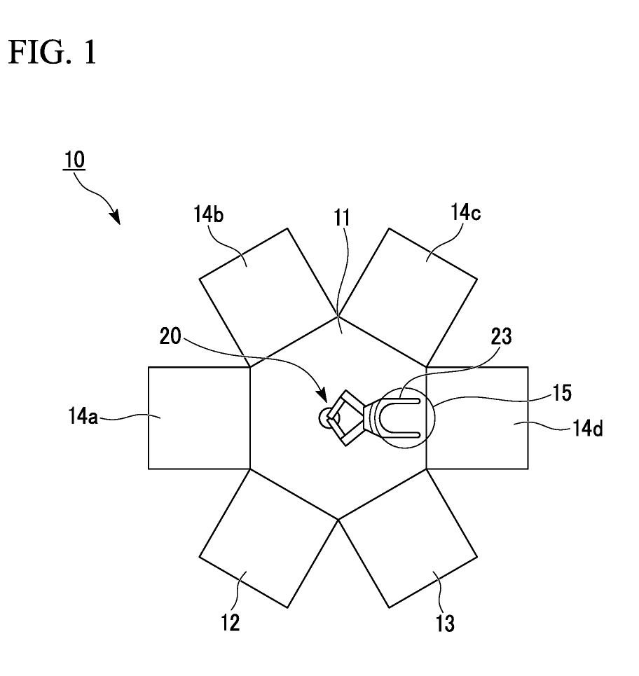

FIG. 1 is a plan view showing a first configuration example of a vacuum apparatus having a transport robot which performs teaching.

A multi-chamber type vacuum apparatus 10 has a transport chamber 11, and a transport robot 20 is disposed in the transport chamber 11. The transport robot 20 transports, for example, a substantially discoid substrate 15 subjected to a treatment in the vacuum apparatus 10.

To the periphery of the transport chamber 11, a carry-in chamber 12, a carry-out chamber 13, and a plurality of treatment chambers 14a, 14b, 14c, and 14d are connected. The substrate 15 which is a transported matter can be moved between the chambers 11 to 13 and 14a to 14d by the transport robot 20.

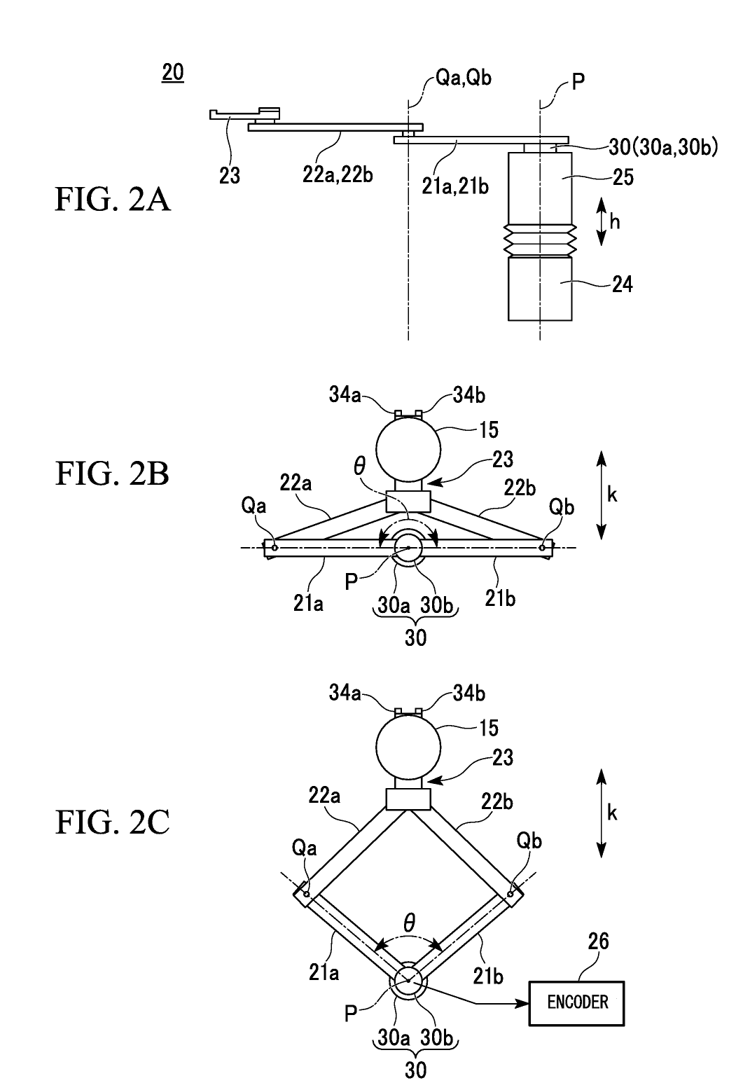

FIG. 2A is a side view of the transport robot 20. FIGS. 2B and 2C are plan views of the transport chamber 11 seen down from the ceiling side. The transport robot 20 has a rotating shaft 30, first and second active arms 21a and 21b, first and second driven arms 22a and 22b, a hand 23, and an up-and-down movement device 24.

The rotating shaft 30 includes an outer cylinder 30a and an inner cylinder 30b disposed inside the outer cylinder 30a. The outer cylinder 30a and the inner cylinder 30b are connected to a concentric biaxial motor 25 and can be independently rotated about the same rotational axis line P. In addition, as shown in FIG. 2C, an encoder 26 described later is connected to the concentric biaxial motor 25. The encoder 26 detects the movements of the active arms 21a and 21b or the driven arms 22a and 22b during robot teaching, for example, the detects strokes or angles of the arms.

The up-and-down movement device 24 moves up and down movable parts such as the active arms 21a and 21b, the driven arms 22a and 22b, and the hand 23 along the height direction h (FIG. 2A).

One of the first and second active arms 21a and 21b is fixed to the outer cylinder 30a and the other thereof is fixed to the inner cylinder 30b. In this embodiment, the first active arm 21a is fixed to the outer cylinder 30a, and the second active arm 21b is fixed to the inner cylinder 30b. The first and second driven arms 22a and 22b are attached to the front end portions of the first and second active arms 21a and 21b to be able to turn respectively. In this embodiment, the first driven arm 22a is attached to the front end portion of the first active arm 21a to be able to turn, and the second driven arm 22b is attached to the front end portion of the second active arm 21b to be able to turn.

The rotating shaft 30 is vertically disposed so that the rotational axis line P is vertical, and the first and second active arms 21a and 21b and the first and second driven arms 22a and 22b are disposed horizontally. Therefore, the first and second active arms 21a and 21b and the first and second driven arms 22a and 22b can be moved on a horizontal plane.

First and second turning axis lines Qa and Qb are turning centers of the first and second driven arms 22a and 22b with respect to the first and second active arms 21a and 21b respectively. The distance between the first turning axis line Qa and the rotational axis line P is equal to the distance between the second turning axis line Qb and the rotational axis line P.

With the configuration as described above, the hand 23 that supports the substrate 15 is able to rotate about the rotational axis line P, and is able to move horizontally along the direction k (the horizontal movement direction of the hand) shown in FIG. 2B. That is, as shown by the direction k in FIGS. 2B and 2C, the hand 23 horizontally moves in a direction away from the rotational axis line P or horizontally moves in a direction approaching the rotational axis line P. In addition, the hand 23 can be moved up and down along the height direction h perpendicular to the horizontal direction by the up-and-down movement device 24. That is, the hand 23 is able to move in 3D directions of XYZ in predetermined ranges. Accordingly, the substrate 15 which is a transported matter can be moved freely between the chambers 11 to 13 and 14a to 14d (see FIG. 1)

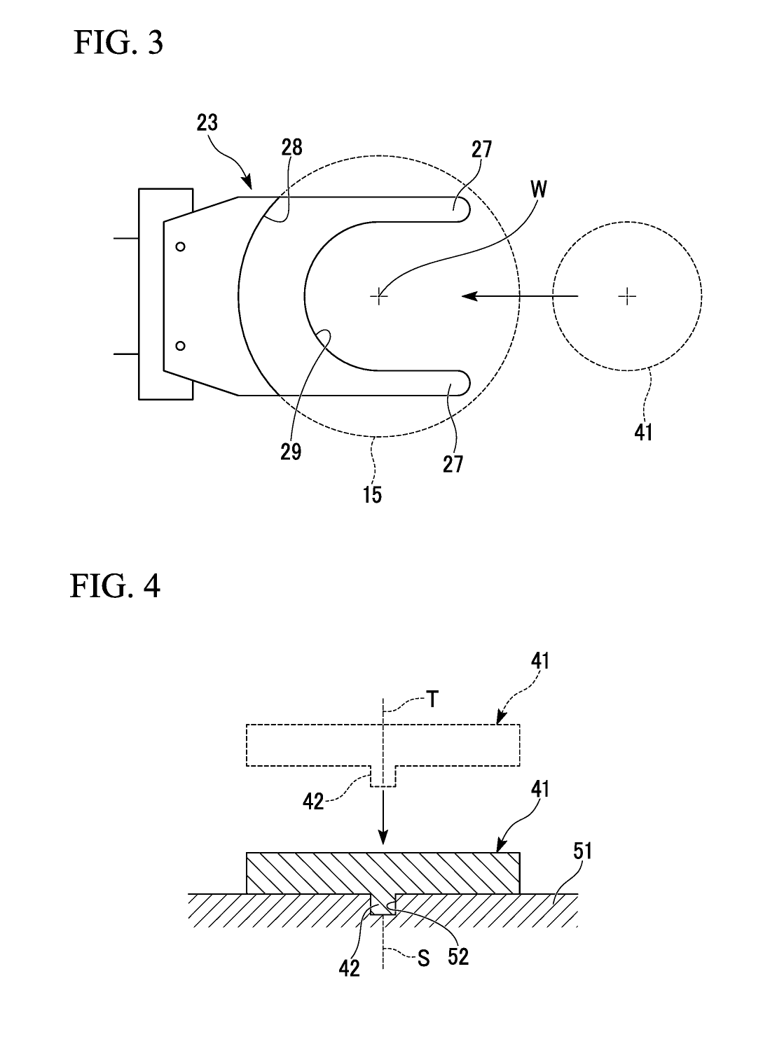

FIG. 3 is an enlarged plan view showing the hand 23 according to a first example, which supports the substrate 15.

In the hand 23, a fork 27 which mounts the substrate 15, and a support end 28 are formed, in which the support end 28 is formed to have the same curvature as the peripheral surface of the substrate 15 and abuts the peripheral edge of the substrate 15 when the substrate 15 is supported. In this embodiment, the shape of the support end 28 can be formed to correspond to the shape of the supported substrate 15. In addition, an abutting portion 29 is formed in the vicinity of the center of the fork 27. The abutting portion 29 may be configured to have, for example, a surface with the same curvature as that of the peripheral surface of a substantially discoid positioning jig 41 which is used during robot teaching described later. In this embodiment, the shape of the abutting portion 29 can be formed to correspond to the peripheral surface shape of the positioning jig 41.

FIG. 4 is a side cross-sectional view showing a state where the positioning jig 41 is disposed at a reception spot and shows an example of the positioning jig 41 used when robot teaching is performed. The positioning jigs 41 used when teaching is performed are installed at, for example, a plurality of reception spots (hereinafter, referred to as stages) that receive the substrate 15 which is a transported matter. The positioning jig 41 is made from, for example, a cylindrical member and has a positioning projection (index) 42 formed at the center T of a surface (bottom surface).

In addition, when the positioning jig 41 is installed on a stage 51 in advance during robot teaching, the positioning jig 41 is installed so that the positioning projection (index) 42 is inserted into a recessed portion (index) 52 formed at the center of the stage 51, that is, the center S of an area where the substrate is placed. Accordingly, the positioning jig 41 can be easily installed on the stage 51 so as to cause the center T of the positioning jig 41 to be aligned with the center S of the stage 51.

Next, the teaching method of a robot using the transport robot having the configuration as described above will be described.

In use of the transport robot, the hand 23 needs to be accurately induced to a reception position (mount position) of the substrate 15 in each of the chambers 11 to 13 and 14a to 14d of the vacuum apparatus 10. For example, an acceptable installation error of the substrate 15 at the reception position is equal to or less than ±1 mm, and preferably, is equal to or less than ±0.2 mm

With regard to the acceptable installation error, when the substrate 15 is received by the hand 23 via an intermediate chamber, it is not preferable to generate dust as the hand 23 and the substrate 15 come into contact with each other at an unexpected point. For example, when a deviation of equal to or more than ±1.5 mm occurs, there is a concern of the side surface of the substrate 15 coming into contact with the peripheral portion of the hand 23. On the other hand, when the stop position precision of the hand 23 is ±0.15 mm, it is preferable that the acceptable installation error be equal to or less than ±0.2 mm

On the other hand, when the substrate 15 is placed at positions other than the intermediate chamber, in a case where the substrate 15 is, for example, a discoid substrate of 300 mm and the diameter of an electrostatic chuck is 294 mm, when the discoid substrate is deviated by 3 mm or greater, the surface of the electrostatic chuck of the stage 51 is exposed and thus a treatment such as film formation or etching is performed even to the electrostatic chuck. When wrap-around formation of a film is not allowed for the side surface or the rear surface of the substrate 15, the acceptable installation error is required to be in the range of an acceptable installation error of, for example, ±0.5 mm or less.

Therefore, previously to the operation of the transport robot, first, a worker referred to a “teaching man” actually moves the hand 23 in a desired operation, and the movement is detected by the encoder 26, thereby generating an operation program (robot teaching). That is, the position of the hand is calculated and teaching data for the robot is generated, for example, by a controller, on the basis of information obtained by the encoder 26.

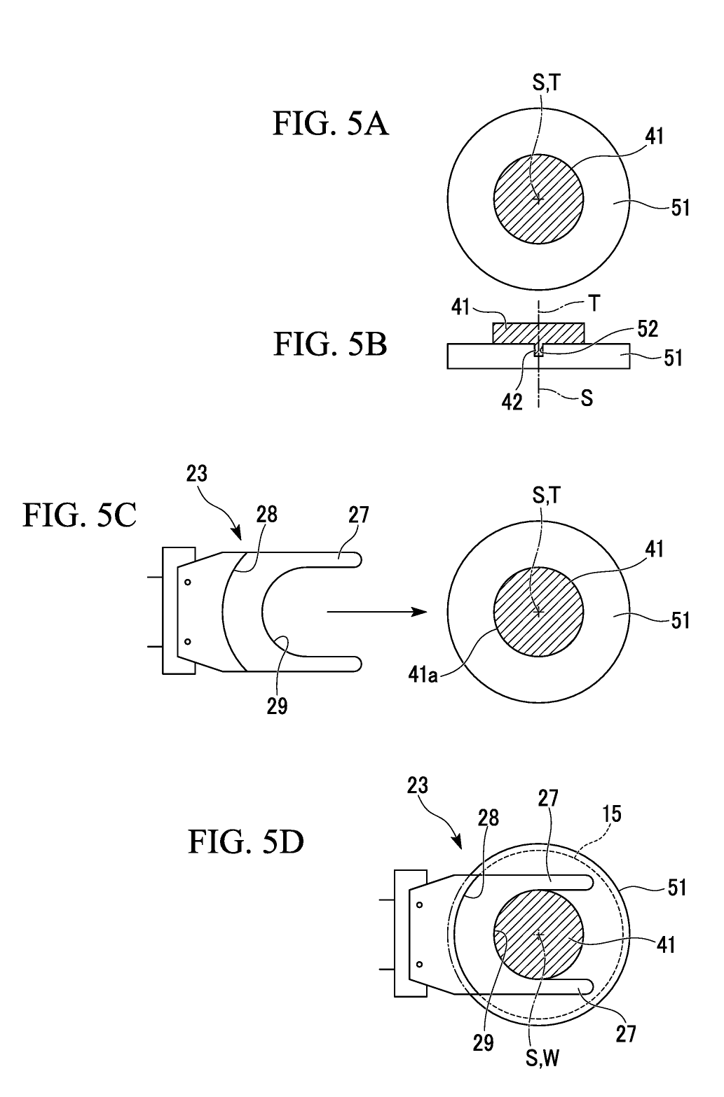

FIGS. 5A, 5C, and 5D are explanatory view showing the teaching method of a robot according to the first embodiment in stages.

As shown in FIG. 5A, when teaching of the transport robot is performed, first, the substantially discoid positioning jigs 41 are installed on all the stages (reception spots) 51, 51 . . . to which the substrates are received by the transport robot (a jig disposing process).

During installation of the positioning jig 41, as shown in FIG. 5B, the positioning jig 41 is installed so that the positioning projection (index) 42 is inserted into the recessed portion 52 formed at the center S of the stage 51, that is, the center S of the area where the substrate is placed. Accordingly, the positioning jig 41 can be easily installed on the stage 51 so that the center T of the positioning jig 41 is aligned with the center S of the stage 51.

Next, after the encoder 26 (see FIG. 2C) is set to a recording state, the hand 23 is actually moved toward the stage 51 (see FIG. 5C).

In addition, the hand 23 is inserted so that the positioning jig 41 disposed on the stage 51 is nipped by the fork 27 of the hand 23. In addition, the hand 23 is moved to a position at which a peripheral surface 41a of the positioning jig 41 abuts the abutting portion 29 of the hand 23, and this position in the abutting state is recorded as a stop position (reception position) of the hand 23 at the stage 51 (a teaching process).

Here, the center axis T of the positioning jig 41 is disposed to be the same as the center axis of the substrate 15 when the substrate 15 is placed on the stage 51. In addition, the hand 23 is moved to the position at which the abutting portion 29 made of a curved surface with the same axis as the center axis W of the substrate 15 when the substrate 15 is supported by the hand 23 abuts the peripheral surface 41a of the positioning jig 41, and this position is recorded as the stop position of the hand 23 at the stage 51, so that it is possible to transport the substrate 15 to the center of the stage 51 accurately and without error.

That is, the center axis of the positioning jig is disposed to be the same center axis as the transported matter when the transported matter is placed at the reception spot. In addition, as the hand is moved to the position at which the abutting portion made of the surface having the same axis as the center axis when the transported matter is supported by the hand abuts the peripheral surface of the positioning jig and this position is recorded as the reception position of the hand, a driving program of the robot capable of transporting the transported matter to the center of the reception spot accurately and without error can be generated.

Moreover, during such teaching, even though a method which involves time and labor such as disposing an index representing the stop position of the hand 23 at the reception position using laser beams as in the related art is not used, by only installing the positioning projection 42 formed in the positioning jig 41 to be engaged with the recessed portion 52 formed at the center of the stage 51, the positioning jig 41 can be easily installed at the center of the stage 51.

Thereafter, simultaneously, by moving the hand 23 to the plurality of stages (reception stops) 51, 51, . . . in a desired operation, and then recording the position at which the abutting portion 29 of the hand 23 at each of the stages 51 abuts the peripheral surface 41a of the positioning jig 41 as the stop position, teaching of the transport robot 20 can be performed easily within a short time.

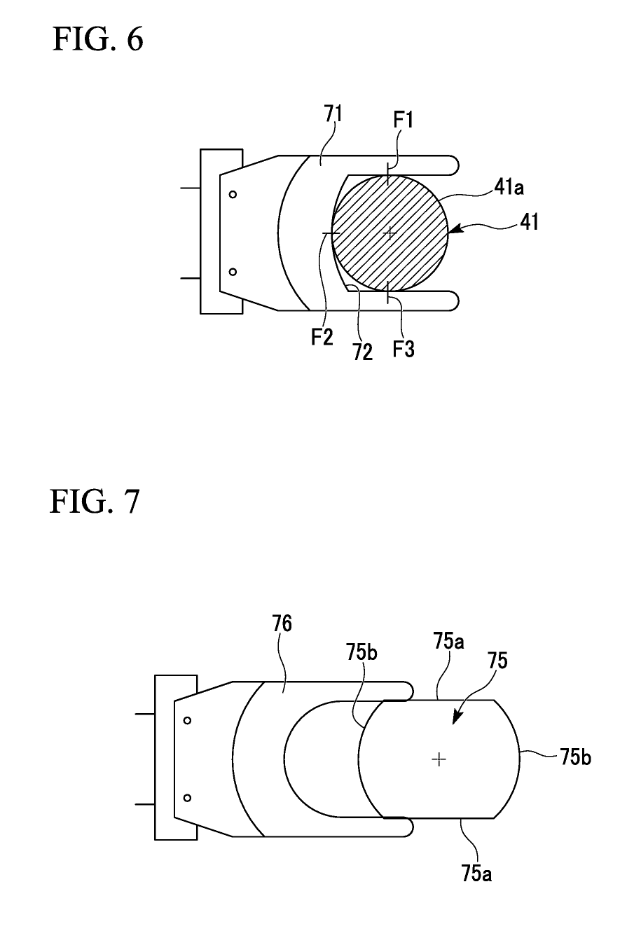

In addition, the abutting surface of the abutting portion 29 which abuts the positioning jig 41 is not necessarily a curved surface having the same curvature as the peripheral surface 41a of the positioning jig 41. For example, as shown in FIG. 6, an abutting portion 72 of a hand 71 may be formed so as to abut on the peripheral surface 41a of the substantially discoid positioning jig 41 installed on the stage (reception spot) at least at 3 points F1 to F3.

In addition, the positioning jig 41 is not necessarily cylindrical. For example, as shown in FIG. 7, the shape of the positioning jig 75 may be formed so that both side surfaces are flat surfaces 75a and front and rear surfaces in the insertion direction to the hand 76 form curved surfaces 75b. Accordingly, deviation when the positioning jig 75 is inserted into the hand 76 is reduced and insertion of the positioning jig 75 during teaching becomes easy.

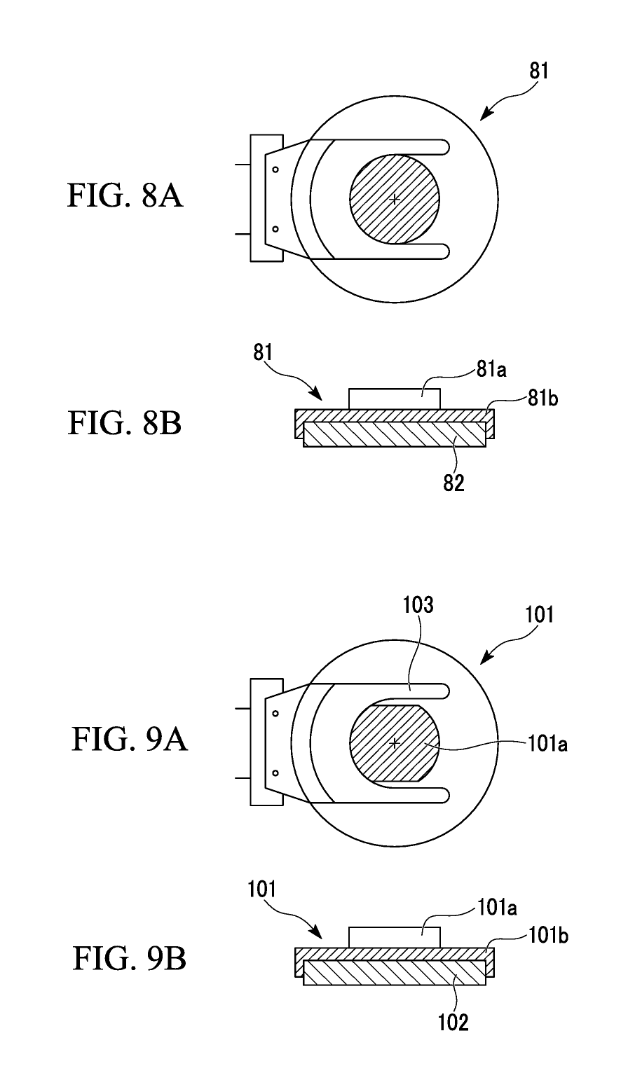

The method of installing the positioning jig on the stage is not limited to the engagement of the projection and the recessed portion as described above. For example, as shown in FIGS. 8A and 8B, the shape of a positioning jig 81 may be configured of an upper portion body 81a which abuts (is engaged with) a hand 83 included in the robot and a lower portion body 81b engaged with a stage 82.

In this configuration, when the positioning jig 81 is disposed on the stage 82 during teaching, by only covering the stage 82 with the lower portion body 81b, the positioning jig 81 can be accurately disposed at the center of the stage 82. In addition, since the stage 82 does not need to be provided with a hole (opening) or the like, the teaching method of a robot of the invention can be applied to a transport robot which is difficult to be newly provided with an opening, such as an existing stage.

In addition, for example, as shown in FIGS. 9A and 9B, the shape of a positioning jig 101 may be formed to have flat surfaces 101a obtained by partially cutting a circle, and cause the width between the flat surfaces 101a to be smaller than the width of the hand 103. Accordingly, friction when the positioning jig 101 is inserted into the hand 103 is reduced, so that a reduction in the positioning precision due to attrition of the jig can be prevented.

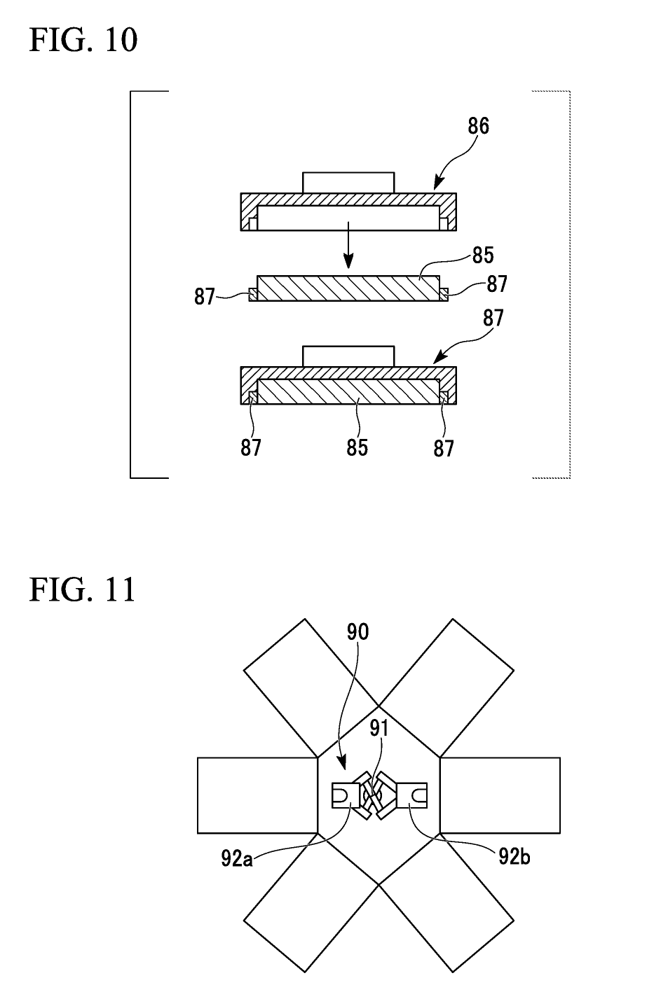

In addition, as shown in FIG. 10, a structure in which an index 87 which induces a positioning jig 86 is provided at the periphery of a stage 85, and the positioning jig 86 is disposed on the stage 85 to be engaged with the index 87 may be employed.

When the positioning jig is installed, in order to teach the hand by being abut from a plurality of different angles, it may fix the positioning jig using a fixing member such as a screw. Accordingly, deviation of a recording position in a pressing direction when the hand is pressed due to rattling between the positioning jig and the installation position can be prevented.

Moreover, it is preferable to form the positioning jig so that the position of the head portion of the positioning jig is at a height flush with the position of the upper surface of the hand when the hand is pressed against the positioning jig. Accordingly, even when there is no margin in the height of the reception position, the invention can be applied.

A robot to which the teaching method of a robot according to the embodiment of the invention can be applied is not limited to the robot having the configuration shown in FIG. 1. For example, as shown in FIG. 11, the invention can be appropriately used for teaching of a transport robot 90 which has two hands 92a and 92b disposed to be symmetrical with respect to a single movable shaft 91 as the center.

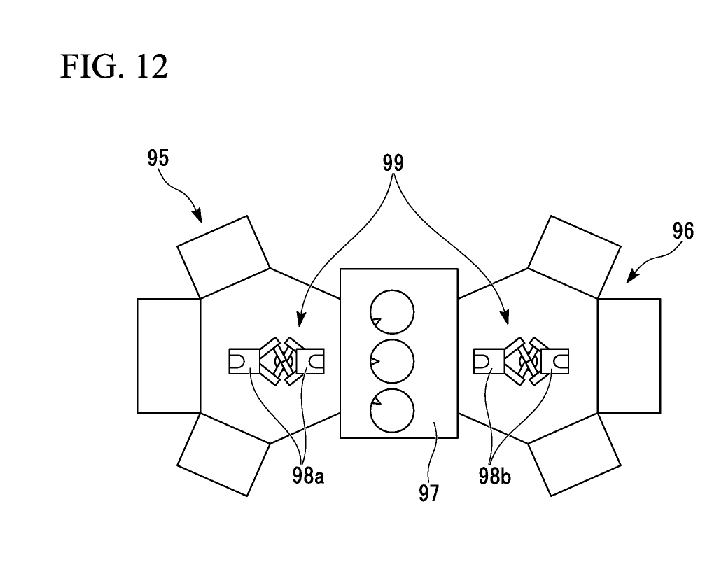

In addition, for example, as shown in FIG. 12, the invention can be appropriately used for teaching of a transport robot 99 having two hands 98a and 87b that transport transported matters (substrates) between two vacuum apparatuses 95 and 96 and reception chambers 97 provided therebetween.

In the foregoing description, the substantially discoid substrate is described as the transported matter. However, the invention is not limited thereto, and a quadrangular substrate may also be transported.

### INDUSTRIAL APPLICABILITY

According to the teaching method of a robot according to the embodiment of the invention, a transported matter can be transported accurately and without error.

### DESCRIPTION OF THE REFERENCE SYMBOLS

10 transport robot (robot)

15 substrate (transported matter)

23 hand

29 abutting portion

41 positioning jig

51 stage (reception spot)

What is claimed is:

1. A teaching method of a robot which supports a transported matter with a hand and transports the transported matter between two or more reception spots, the teaching method of robot comprising:
a jig disposing process of disposing a positioning jig at the reception spot so as to have the same center axis as the transported matter when the transported matter is placed at the reception spot; and
a teaching process of moving the hand to a position at which an abutting portion of the hand abuts the positioning jig at each of the reception spots and teaching the position of the hand to a controller.

2. The teaching method of a robot according to claim 1, wherein the abutting portion uses a surface abutting a peripheral surface of the positioning jig at a position at which the center axis of the positioning jig overlaps the center axis of the transported matter when the transported matter is supported by the hand.

3. The teaching method of a robot according to claim 1, wherein, when the positioning jig is disposed at the reception spot, an index is used which induces the positioning jig to a position at which the center axis of the positioning jig and the center axis of the transported matter overlap each other.

4. The teaching method of a robot according to claim 1, wherein the reception spots are spots at which the transported matter is received between a plurality of robots.

5. The teaching method of a robot according to claim 1, wherein the robot is driven by a servo-motor.

6. The teaching method of a robot according to claim 1, wherein the robot is subjected to an expansion and contraction movement and a turning movement by a concentric biaxial motor.

7. A teaching apparatus of a robot comprising:
a robot which supports a transported matter with a hand having an abutting surface and transports the transported matter between two or more reception spots;
an encoder which is connected to the robot to obtain information regarding the robot;
a controller which calculates a position of the hand on the basis of the information obtained by the encoder and generates teaching data for the robot; and
a positioning jig which is disposed at the reception spot so as to have the same center axis as the transported matter when the transported matter is placed at the reception spot, when the positioning jig abuts the abutting surface of the hand.

8. The teaching apparatus of a robot according to claim 7, wherein the robot is a vacuum transport robot.

9. The teaching apparatus of a robot according to claim 7, wherein
at least a part of a peripheral surface of the positioning jig has a curved surface shape, and
the abutting surface of the hand abuts the peripheral surface of the positioning jig at least at three points.

10. The teaching apparatus of a robot according to claim 7, wherein the abutting surface of the hand is a curved surface having the same curvature as an abutting peripheral surface of the positioning jig.

11. The teaching apparatus of a robot according to claim 7, wherein
a projection portion is formed at a surface of the positioning jig, and
a recessed portion engaged with the projection portion is formed at a surface of the reception spot.

12. The teaching apparatus of a robot according to claim 7, wherein
a projecting peripheral wall surface is formed at one surface of the positioning jig,
a projecting portion having a peripheral surface that abuts the abutting surface of the hand is formed at the other surface of the positioning jig, and
in a state where the positioning jig is disposed at the reception spot, the reception spot is stored in a recessed portion provided by the peripheral wall surface.
